(19) United States
(12) Patent Application Publication
(10) Pub. No.: US 2004/0042772 A1
(43) Pub. Date: Mar. 4, 2004

(54) Thermostat system to provide adaptive control of water temperature

(76) Inventors: Geoffrey M. Whitford, Dundas (AU); Ljubomir Milutinovic, Abbotsford (AU)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/456,784

(22) Filed: Jun. 9, 2003

Related U.S. Application Data
(63) Continuation-in-part of application No. PCT/AU01/01633, filed on Dec. 18, 2001.

(30) Foreign Application Priority Data
Dec. 18, 2000 (AU) PR 2127

(51) Int. Cl. H05B 1/02

(52) U.S. Cl. 392/498

(57) ABSTRACT

A water heater heating control system including: a thermostat with an adjustable set-point temperature, wherein the set point of the thermostat is adjusted in response to the cold water supply temperature.

This is a continuation-in-part (CIP) application of International Application PCT/AU01/01633 with an international filing date of Dec. 18, 2001, published in English under PCT Article 21(2) and now abandoned.

### FIELD OF THE INVENTION

This invention relates to a programmed electronic thermostat for a water heater that changes its set point automatically within pre-programmed limits as a function of the temperature of the cold water available.

### BACKGROUND OF THE INVENTION

Complex and expensive tempering valves are interposed between storage water heaters and bathrooms or en-suite bathrooms, to guard against any possibility of people being scalded by hot water accidentally delivered to a shower or bath. In certain types of washing facilities, such as in homes for aged people, such tempering valves are already mandatory.

It would be advantageous to encourage usage of a tempering valve in domestic applications also, because occasionally accidents occur, for example, to young children. Young children have been badly burned in accidents where they have fallen into baths being filled with water at the maximum storage temperature of the water as stored in the water heater, namely 65-70° C. Despite this, the relative infrequency of this type of accident mitigates against inducing the population to accept en masse water heater equipped with a tempering valve controlled outlet, because of higher cost.

The temperature required for a hot shower varies with individuals, seasons and other factors but generally lies in the range of 38° C. to 44° C. It is desirable to provide water at less than 50° C. (i.e., will not readily scald) that can be cooled to the precise temperature required by adjustment, at the point of use, such as by a conventional hot and cold tap, by the person showering, washing or bathing.

For water temperatures less than 50° C. there is a substantially more safe contact time before third degree bums occur. At 50° C. the safe contact time for adults and children is 5 minutes. Table 1 below shows how this time is substantially reduced at higher temperatures.

TABLE 1
Time taken to produce third degree burns from hot water

Contact time to third degree burn

| Temperature, Celsius | Adults | | Children | |
|---|---|---|---|---|
| 50 | 5 | minutes | 5 | minutes |
| 55 | 30 | seconds | 7 | seconds |
| 60 | 5 | seconds | 1 | second |
| 70 | 1 | second | 0.5 | seconds |

### SUMMARY OF THE INVENTION

The present invention provides a water heater heating control system including: a thermostat with an adjustable set-point temperature, wherein the set point of the thermostat is adjusted in response to the cold water supply temperature.

The system can further include a set point adjustment means coupled to a temperature sensor, said temperature sensor being configured to determine the cold water supply temperature, and provide a signal to said set point adjustment means based on said cold water supply temperature.

The system can also include a switch to energise a resistive heating element when heating water in a tank of a water heater and which interrupts heating of the water, said system having said temperature sensor located to provide a signal related to the cold water supply temperature; signal processing means to produce a signal relating to the temperature measured; input/output relationship means to alter the set-point temperature of the thermostat according to a relationship which modifies the set-point temperature according to changes measured in the supply temperature.

The temperature sensor can be located near the lower end of the tank so as to measure the temperature of the water which flowed into the tank from the water supply. The temperature sensor can be incorporated in or associated with the thermostat.

The temperature sensor can measure the temperature of water stored near to the lower end of the tank prior to availability of off peak electricity supply being engaged.

Alternatively the temperature sensor can measure the temperature of water stored near to the lower end of the tank after a predetermined amount of water has been drawn for said tank.

The system can include a second temperature sensor element located remotely from the thermostat to provide a signal related to the supply temperature of the water before it enters the tank.

The input/output relationship means can be in the form of a look up table stored or generated by said control system, which can be stored in a non-volatile memory at the time of manufacture or which can be programmed into a non-volatile memory from a remote location, for example using the off-peak signalling system or otherwise within the knowledge of a person skilled in the art.

Alternatively the set point can be generated by calculating the difference between a desired output temperature and the cold water supply temperature and adding twice this difference to the cold water supply temperature of the water. The desired output temperature is less than 50° C. and is preferably greater than 30° C.

The desired output temperature from the water heater can be achieved by the simple union of water from the cold water supply mixing with the water from the water heater in a ratio of 1:1.

The present invention also provides a method of controlling the heating of a water heater, said method including: (a) measuring cold water supply temperature for a water heater tank; (b) identifying or calculating a thermostat cut out temperature using the measured cold water supply temperature and a desired output temperature; (c) closing the circuit with a heating element to heat water in said tank until the thermostat detects a temperature substantially the same as said temperature identified or calculated in step (b), Step (a) can be performed before water from the cold water supply enters the tank.

Alternatively step (a) can be performed after water from the cold water supply has entered the tank.

Step (a) can be performed after a predetermined amount of hot water has been drawn from the tank.

Step (a) can alternatively or also be performed prior to availability of off peak electricity supply.

The set point temperature can be identified from a look up table stored in the control system of said water heater, which can be stored in a non-volatile memory at the time of manufacture, at installation or which can be programmed into a non-volatile memory from a remote location.

The method can include the step of choosing an appropriate look up table based upon a desired output temperature and the cold water supply temperature.

The set point temperature can be calculated from a desired mixed output temperature and the cold water supply temperature. The set point temperature can be calculated by adding the cold water supply temperature to twice the difference between a desired mixed output temperature and the cold water supply temperature.

The invention further provides a method of switching a water heater element, said method including the steps of: providing a solid state switching circuit and a relay connected in parallel thereto; initially closing the circuit between an electricity supply and said element by said solid state switching circuit in response to a control signal; after a predetermined time switching said relay.

Preferably said solid state switching circuit is a triac, and said predetermined time is approximately 20 milliseconds. The control signal preferably maintains said solid state switching circuit in an ‘ON’ condition.

To switch off the heater element the relay is switched off first, and after a predetermined time the solid state switching circuit opens the circuit between the supply and the heater element.

The method supplies an AC supply to said solid state switching circuit, said relay and said heating element and said solid state switching circuit will go to an ‘ON’ condition when the voltage is zero.

The invention also provides a water heater element control system, said system having a circuit between a water heater element and a solid state switching circuit and a relay connected in parallel thereto; whereby said solid state switching circuit initially closes the circuit between an electricity supply and said element in response to a control signal and after a predetermined time switching said relay.

Preferably said solid state switching circuit is a triac, and said predetermined time is approximately 20 milliseconds.

The control signal preferably maintains said solid state switching circuit in an ‘ON’ condition.

To switch off the heater element the relay is switched off first, and after a second predetermined time the solid state switching circuit opens the circuit between the supply and the heater element.

The method supplies an AC supply to said solid state switching circuit, said relay and said heating element and said solid state switching circuit will go to an ‘ON’ condition when the voltage is zero.

### BRIEF DESCRIPTION OF THE DRAWINGS

Embodiments of the present invention will now be described, by way of example only, with reference to the accompanying drawings in which:

FIG. 1 shows an electronic schematic diagram of the thermostat for use with the invention;

FIG. 2 illustrates a flow chart of the processes involved in the control system of the first embodiment; and

FIG. 3 illustrates a flow chart of the processes involved in the control system of a second embodiment.

### DETAILED DESCRIPTION OF THE EMBODIMENTS

Throughout the specification and claims the expression “cold water supply” refers respectively to the water which is supplied to the water heater for heating, irrespective of its temperature. While most water supplies have a temperature which “feels” cold, in some areas the actual supply temperature may not give this impression of being cold.

Embodiments of the invention provide a water heater control system and method of using such a system which controls the set point temperature of a thermostat of the water heater in response to the temperature of the cold water supply delivered to the water heater for heating.

The embodiments help to prevent scald and burns to users of hot water delivered from the water heater. This is done by hot water from the water heater being mixed at a predetermined ratio with the cold water supply at the same temperature as that delivered to the hot water heater for heating at the cold water supply temperature, in order to deliver water at a safe temperature. In this regard once the mixing ratio of cold water and heated water is set (this being done not by mixing valves, but simply by having the hot water and cold water pipes being connected to a T union or such like, with each pipe being of the same diameter and the same pressure being available in each pipe) the preferred embodiment provides for an adjustment of the temperature of hot water produced by the water heater in response to changes in the cold water supply temperature.

The embodiments provide for a number of preferred means for determining the temperature of water produced by the water heater, i.e. the set point temperature of the water heater thermostat, namely by using a calculation performed by the controller of the water heater or through using one or more stored lookup tables, which can be stored in a non-volatile memory at the time of manufacture or which can be programmed into a memory from a remote location using a known signalling system, for example the off-peak signalling system using a dual tone multi-frequency (DTMF) modulation or some other form of modulation.

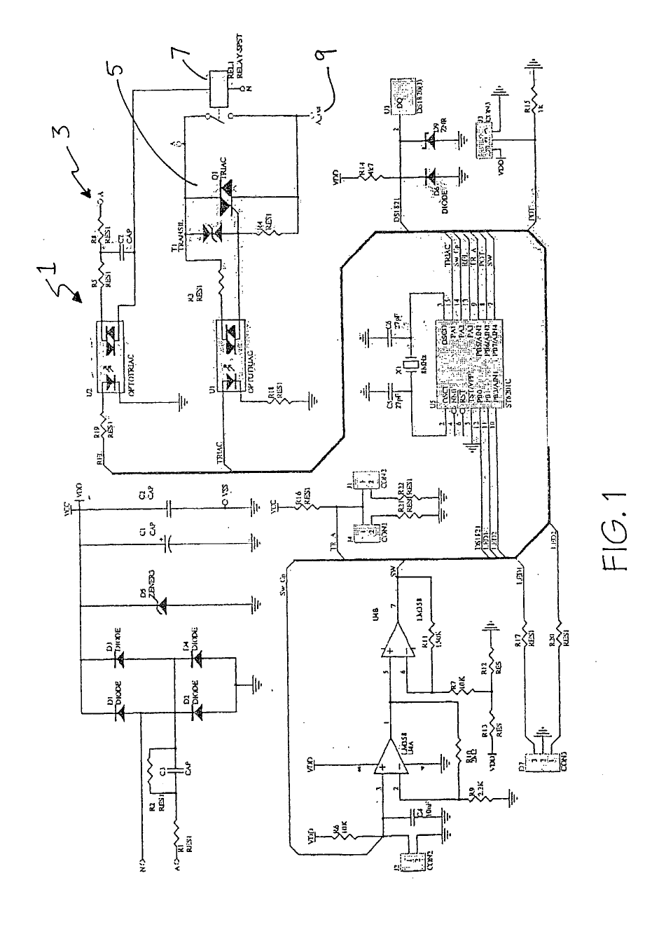

FIG. 1 shows an electronic schematic diagram of a thermostat and control system 1 capable of being used in an embodiment of a water heater heating control system according to an embodiment of the present invention. Switching of the resistive heater element (not illustrated but connected to terminal 9 in FIG. 1) in the hot water system is realised by means of a hybrid solid state/mechanical configuration 3. In this way the advantages of both mechanical and solid state devices are utilised in providing the power rating, reliability and compactness of the thermostat.

The solid state component used is a triac 5 which operates with little or no noise and can be controlled at precise instants with no rebounds. The triac 5 also has automatic turn-off when the alternating current falls to zero after the control signal has been removed and has an ability to withstand, without mechanical wear, an unlimited number of operating cycles.

Since the triac 5 has a very fast switch-on time, the load of the heater element can be switched on precisely as the mains voltage crosses the zero point between cycles. This ensures that starting current is always zero and thus provides benefits in reducing surge currents, mains network pollution, electromagnetic interference and radio frequency interference. It also provides freedom from arcing at contacts and enables regulation of the output power on the heater element from zero to its maximum rating by using either proportional or phase delay methods. To avoid the potential disadvantage of having to provide an expensive heat sink arrangement, the triac 5 utilises a relay 7 to carry the preswitched current to the element and to thereby relieve the triac 5 of heat dissipation. The relay 7 does not wear its contact during switching because the main current is already carried by the triac 5. The water heater element is initially switched on by the solid state triac 5. After about 20 milliseconds the relay 7 is switched on to take all or most of the current passing through the triac 5. During the initial 20 ms the triac 5 will not generate appreciable heat and even without a heat sink, will not suffer a reduction of its life. The triac 5 will remain in an ‘ON’ condition due to a control signal, while the current is being passed through the relay 7.

During the switching off cycle, the relay 7 is switched off first, with current continuing to flow but through the triac 5, which has remained in an ‘ON’ condition due a control signal. Again, the relay 7 does not wear its contact because it does not switch off the load current. After 35 ms the triac 5 is switched off and the heater element is disconnected at the end of the current half-wave period of the mains when its current falls to zero. A safe current rating for the configuration described is 30 amps.

The temperature of the water in the tank is sensed by a dry sensor affixed in heat transfer relationship to the outside of the tank wall. The sensor is a digital programmable sensor which converts the temperature sensed and transmits it to the host controller in digital 9-bit 2's complement format, giving an accuracy of 10.5° C. in the range of operating temperatures applicable to water heater use. Using this sensor the controller can accurately manage very low temperature differentials and keep the maximum temperature cut-out at a very precise set-point.

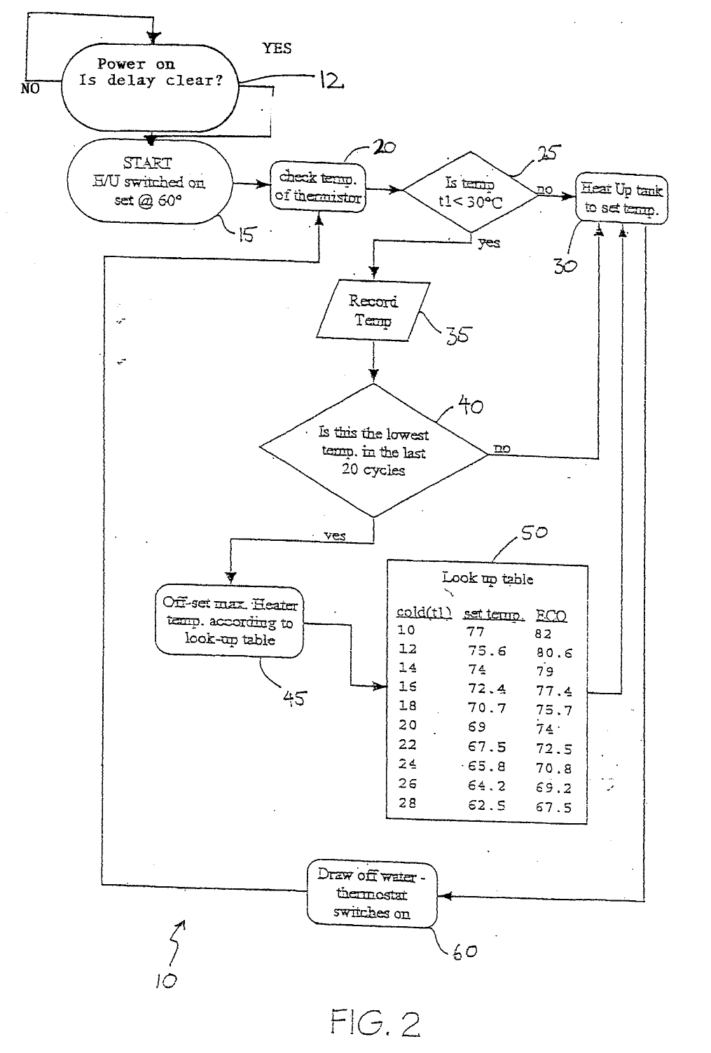

To minimise or eliminate the temperature overshooting due to the system differential, an appropriate digital proportional-integral regulator is implemented to adjust the transfer function of the controller and overall system and to predict in advance cut-in and cut-out temperature points. FIG. 2 shows an algorithm indicating how the programming of the set point of the thermostat is changed in conjunction with a thermistor measuring the temperature of the water in the cold water supply line and a stored memory look-up table which then adjusts the set-point temperature as indicated in the table. The energy cut-out temperature setting may also be set as indicated. The thermostat can be of a wide variety of forms of electronic thermostat. Merely one of its presently preferred forms will be described below. The electronic thermostat can be used to provide additional features of convenience in the operation of the water heater.

In particular, the stored memory look-up table can be stored in a non-volatile memory at the time of manufacture or can be programmed into a non-volatile memory by a serviceperson installing a unit or can be programmed into a non-volatile memory from a remote location. For example, the power line connection used for the off-peak switching, a telephone connection, whether a land line or a wireless connection, can be used to program the memory.

It is believed the increased convenience of automatic operation combined with the incremental increase of cost of the thermostat additional features will not yield an unacceptable price for domestic consumers to adopt a virtually accident proof system in regard to avoidance of scalding associated with personal washing.

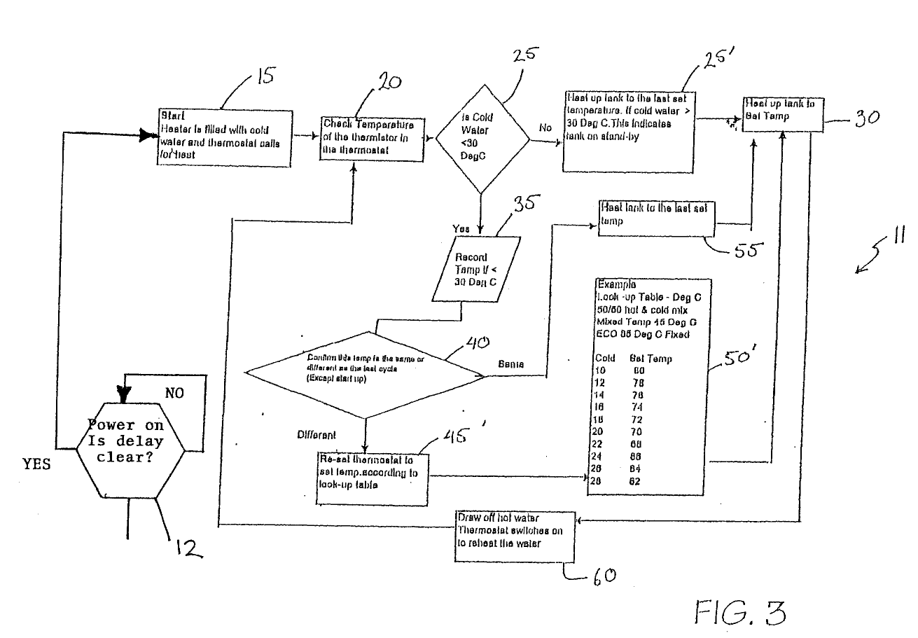

Turning now to FIGS. 2 and 3 which show flow charts depicting two embodiments of methods for controlling a water heater heating system.

Turning firstly to FIG. 2, the flow chart shows an operation algorithm for a water heater in which the hot water drawn off the water heater will be mixed with cold water supply downstream from the water heater in order to provide water of a fixed temperature. This predetermined mixed water temperature is used to determine the values used in the lookup table in this embodiment.

The method 10 begins by switching on the water heater with a temperature set point of 60 degrees. If desired and the controller has a means to identify the date or time of year, a look up table can be provided of average cold water supply temperatures in the region of installation of the water heater. Alternatively, the look-up table can be programmed into non-volatile memory by a serviceperson installing a unit or can be programmed into non-volatile memory from a remote location. The memory lifetime is for the life of the product or until the non-volatile memory is over written.

The water heater can be provided with a clock/timer to provide time of day/year as well as to provide timing for various functions of the water heater. For example, one process can include setting the timer when the electricity is turned on in order to provide a delay before electricity is supplied to the thermostat and heater element. A value is written to non-volatile memory which can be cleared once the delay has timed out. If there has been a black-out during the delay period then further delay can be undesirable. Hence, upon electricity re-supply, the non-volatile memory, which will not have been cleared, as the delay will not have timed out, can be cleared and electricity connected without any further delay.

Thus if the power was interrupted during the delay period, then electricity is supplied to the thermostat and heater element straight away upon restoration of electricity.

Equally, if the power was cut off during the heating period then the control system can be sequenced so that the power will also come on straight away. The maximum memory time is for the life of the product or until the non-volatile memory is over written.

In addition, the control system can allow for manual intervention. For example, by turning the electricity supply “on-off-on” a black-out is simulated and as stated above, the control system will automatically allow electricity to the heater without delay.

Hence, the first step 12, at power on, as shown in either FIG. 2 or 3, is to “wait” for the required delay to time out which step 12 can thus include first writing a value or code to non-volatile memory and then clearing that memory once the period of the delay has ended.

The delay period can be fixed for a given unit but can be made different for other units manufactured so that at turn-on of the electricity supply, in particular for a heater powered by an off-peak supply, the load on the generating resources is lessened. The delay set can take into account the time required to heat to the desired temperature the quantity of water to be heated knowing the capacity of the water heater, and the time available to do so over the period of electricity supply. In particular, for a water heater heated by an off-peak electricity supply the power to the water heater will be disconnected at the end of the off-peak period.

The delay is different between summer and winter due to the colder water inlet temperature in winter and the time needed to achieve the final required hot water temperature. The hot water temperature can also be different for different seasons to reduce heat losses. To determine the delay, the smart thermostat calculates the amount of energy needed to satisfy the thermostat and subtracts the heating time from the total off-peak time. In particular the maximum delay possible is calculated on the basis of the time required to satisfy the thermostat setting to cease heating just prior to the end of the off-peak period. The delay can be biased or random. The most common biased delay will mean biasing the delay for the maximum delay possible as described above. This arrangement will provide a peak in the electricity supply at the end of the off-peak period. A random delay would provide distributed turn-on and turn-off times thereby providing a more even demand on the electricity supply in the off-peak period tending to fill up the existing trough in the off-peak supply.

Once power is restored and if the delay code has not been cleared, the heater takes the last cold and hot water temperature settings and starts heating without delay.

Storing the program and in particular the look-up table in non-volatile memory means that should an interruption to the power supply occur for whatever reason the control system can continue without loss of function. Equally, the control system can include program steps whereby upon sensing an interruption to the power supply the current parameters of the control system can be saved into non-volatile memory before the voltage level drops too low to enable reliable writing thereto allowing more ready restoration of the function of the control system. For example, a flywheel capacitor can be used for this purpose or a re-chargeable battery.

This temperature set point has been set such that it will produce water at a temperature when mixed with cold water supply, being at a safe temperature for users of the mixed water.

The water heater used in accordance with this method has a first temperature sensing device which is configured to detect the cold water temperature of water entering the tank of the water heater, i.e. checking the cold water supply temperature delivered to the water heater. In addition to the first sensor, a second temperature sensor is incorporated in, or associated with, the thermostat and measures the temperature of the water in the tank near to the base of the tank. Thus two temperature sensors are provided in this embodiment.

The first sensor measures the cold water supply temperature in a cold water delivery pipe preferably within the confines of the water heater.

In step 20 of FIG. 2 the temperature of the cold water supply going to the water tank for heating is determined by the first sensor.

Next in step 25, if the temperature of the cold water supply is greater than 30 degrees, then the water in the tank of the water heater is heated to the set point temperature by the element of the water heater (see step 30). If the cold water supply temperature entering the water heater is less than 30 degrees then the temperature is recorded by the control system in step 35. After the water heater has been running for some time a series of recorded cold water supply temperatures will be stored by the control system allowing step 40 to be performed. Until such time as 20 cycles of the temperature detection and set point loop have been performed a 60 degree set point is maintained and the water heated according to steps 15, 20, 25 and 30.

Once 20 cycles of the set point temperature adjustment loop have been completed it is possible to compare the recorded temperature of the current cycle with the temperatures of the previous cycle to determine whether the cold water supply temperature of this cycle is hotter or colder than previous cycles. In this regard if in the present cycle the cold water supply temperature is not colder than the previous cycles the method continues along to step 30 and the tank is heated to the current set point temperature. If on the other hand the current recorded cold water supply temperature in step 35 is the lowest temperature in the last 20 cycles the set point of the thermostat is adjusted in step 45 in accordance with lookup table 50. The lookup table 50 includes three columns of numbers each row corresponding to a particular cold water supply temperature measured by the sensor.

The lookup table 50 includes for each cold water supply temperature (T1) a set point temperature and an energy cutoff temperature (“ECO”). For each cold water supply temperature T1 the set point temperature is chosen such that the hot water produced by the water heater when mixed with cold water supply of temperature T1 will produce water of a safe temperature for users. The mix is preferably in a hot/cold water ratio of 1:1 as this can be done simply by means of equal diameter pipes (assuming equal diameter pipes and the same or similar water pressure therein) being joined together by a T piece. The ECO temperature is set at an arbitrary temperature above the set point temperature such that the temperature of the water does not rise above the ECO value and thereby use excess energy.

Thus in step 45 if the cold water supply temperature recorded in step 35 is the lowest temperature of the last 20 cycles then the lookup table 50 is consulted and the new set point temperature is chosen according to the measured cold water supply temperature T1. A new set point temperature is then passed to the thermostat and the water is heated up to the new set point temperature in step 30.

In step 60 of FIG. 2 hot water is drawn off the water tank and the thermostat switches back on in order to heat the cold water supply entering the tank to replace the water drawn off. The thermostat switching on in step 60 restarts the loop at step 20 by checking the temperature measured by the sensor which determines the temperature of the cold water supply.

Turning now to FIG. 3 which shows a second embodiment of the method of controlling a water heater. Each of the steps in the method II are numbered similarly to the corresponding step in FIG. 2. Where the steps are numbered identically the step itself is performed in identical fashion to the previous method. One difference between the methods 10 and 11 is that in method 11 the cold water supply temperature is measured inside the tank, by the temperature sensing device incorporated in or associated with, the thermostat. Thus in this embodiment or method 11 only one temperature sensing device is utilised.

Thus, in step 15 the water heater is filled and the thermostat is switched on. Next, in step 20 the sensor incorporated in or associated with the thermostat determines the cold water supply temperature of the water in the base of the tank. In step 25 if the cold water supply temperature determined by the sensor is less than 30 degrees the method proceeds to step 35. On the other hand, if the temperature of the water in the tank is greater than 30 degrees the water heater control system determines, in step 25′ that the water heater is in standby mode and filled with warm water. In this case, the thermostat uses the last set point temperature and heats the water tank up to that set point temperature in step 30.

If the water in the tank of the water heater in step 25 is less than 30 degrees, that cold water supply temperature is recorded in step 35. This temperature is then compared with the cold water supply temperature of the last cycle in step 40. If the temperature of the current cycle and the previous cycle are the same in step 40 the method proceeds to step 55 and the water in the tank is heated up to the last set point temperature. If the cold water supply temperature recorded in step 35 is different, either higher or lower than the previous recorded temperature, (with startup time being an exception), the set point temperature of the thermostat is reset according to the lookup table 50.

It will be noted that the lookup table 50 in this embodiment is different to that of the embodiment of FIG. 2. In this example for each cold water supply temperature a set point temperature is determined with a single ECO value of 85° C. being fixed for all water temperatures. Thus memory in the controller is saved by reducing the amount of stored data in the lookup table. Furthermore, as it will be appreciated by those skilled in the art if the shut off value of the element is set at a single value simplified circuit controls can be implemented in the water heater.

Each time water is drawn from the water heater in step 60 and cold water supply is fed into the tank of the hot water heater the temperature of the cold water supply is checked and the method 11 restarts again at step 20.

It should be noted that alternatives to the lookup table provided can also be implemented. Thus rather than step 45 requiring a lookup table, it is possible to calculate for any given cold water supply temperature and any desired mixed temperature an appropriate set point temperature which is suitable. In this regard, if the hot and cold mixed water are to be mixed in a ratio of 1:1 then for a given cold water temperature Ti the following equation can be used to determine the set point temperature:

T′=2 TD−T1 where T′ is the set point temperature; TD is the desired temperature of water when mixed with cold water in the ratio of 1:1; and T1 is the temperature of the cold water supply.

Thus as an example, if the mixed desired water temperature (TD) is 45° C. then the set point temperature (T′) to achieve where the cold water supply temperature (T1) is 20° C. is:

T′=2(45° C.)−(20° C.)=70° C.

As will be appreciated by those skilled in the art, if a ratio of hot and cold mixing other than 1:1 is utilised then this formula will need to be adjusted in order to account for this change in ratio.

In the lookup tables of FIGS. 2 and 3 when a hot/cold mixing ratio of 1:1 is used, the water temperature which will result will be approximately 45° C. Some minor variation from this figure may occur.

For the embodiments of FIG. 2 or 3, if desired additional control feature can be added whereby a mixed water temperature input can be provided so that a desired mixed water temperature will result for a desired hot/cold mixing ratio, preferably of 1:1. Thus the control system can provide a separate look up table for each of a desired mixed water temperature, say at 1 or 2 degrees apart in a range of desired mixed output temperatures from say 40° C. to 50° C. However, the provision of this option will require a greater amount of memory due to a plurality of look tables being provided. Look up tables with different data will need to be provided if the mixing ratio is not set at 1:1.

If a calculation is used to provide the set point temperature, then a desired mixed water temperature can be input to the control system by a user or the installer and used to calculate the set point temperature by means of the equation as previously.

In addition to the lookup tables or the calculation system referred to above, if the water heater control system detects standby mode, or at the point of switching on the water, and by using a controller which can keep track of the date or time of year, then the controller can consult a lookup table, (which can be region specific) of average cold water supply temperature to determine the starting set point temperature at that time of the year. After which, once hot water is drawn off, the measured cold water temperature supply can be utilised as in the above described methods.

The look up table stored or generated by said control system can be stored in a non-volatile memory at the time of manufacture, during installation or can be programmed into a non-volatile memory from a remote location as required.

In the embodiments described above, the cold water supply temperature can be sensed prior to the water entering the tank. That is a separate cold water supply temperature sensor can be utilised in addition to the temperature sensor incorporated in or associated with the thermostat at the base of the water tank.

Alternatively the system can utilise a single temperature sensor, being the one incorporated in or associated with the thermostat located at the base of the water tank. In this case, this single temperature sensor can be made to sense the temperature of the cold water supply by measuring the temperature of the water entering the tank once a predetermined amount of hot water has been drawn from the tank, or alternatively, in an off peak water heating electrical supply the sensor can measure the water temperature prior to the off peak electricity becoming available.

The importance of consumer acceptability cannot be overemphasised in the context of encouraging consumers to protect themselves and families from a potential scald accident, an event that can rarely be rationally explained after the event. The seriousness of a hot water scald burn is directly dependent on the temperature of the water and the length of contact time. There is a significant difference in the time that it takes to suffer a serious, third degree, scald at different temperatures. A third degree burn is one that affects the full thickness of skin and is likely to require surgery.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention and modifications, obvious to those skilled in the art can be made thereto, without departing from the scope of the present invention.

1. A water heater heating control system including: a thermostat with an adjustable set-point temperature, wherein the set point of the thermostat is adjusted in response to the cold water supply temperature.

2. A water heater heating control system as claimed in claim 1 further including a set point adjustment means coupled to a temperature sensor, said temperature sensor being configured to determine the cold water supply temperature, and provide a signal to said set point adjustment means based on said cold water supply temperature.

3. A water heater heating control system as claimed in claim 2, having an switch to energise a resistive heating element when heating water in a tank of a water heater and which interrupts heating of the water, said system having said temperature sensor located to provide a signal related to the cold water supply deliverable or delivered to the tank; signal processing means to produce a signal relating to the temperature measured; input/output relationship means to alter the set-point temperature of the thermostat according to a relationship which modifies the set-point temperature according to changes measured in the cold water supply temperature.

4. A water heater heating system as claimed in claim 3, wherein said temperature sensor is located near the lower end of the tank so as to measure the temperature of the cold water supply which flowed into the tank.

5. A water heater heating control system as claimed in claim 3, wherein said temperature sensor measures the temperature of water stored near the lower end of the tank prior to availability of off peak electricity supply being engaged.

6. A water heater heating control system as claimed in claim 3, wherein said temperature sensor measures the temperature of water stored near the lower end of the tank after a predetermined amount of water has been drawn from said tank.

7. A water heater heating control system as claimed in claim 6, wherein a second temperature sensor element is located remotely from the thermostat to provide a signal related to the cold water supply temperature before it enters the tank.

8. A water heater heating control system as claimed in claim 3 wherein said electronically stored input/output relationship means is in the form of a look up table stored or generated by said control system.

9. A water heater heating control system as claimed in claim 1, wherein the set point is generated by calculating the difference between a desired output temperature and the cold water supply temperature and adding twice this difference to the cold water supply temperature.

10. A water heater heating control system as claimed in claim 9, wherein said desired output temperature is less than 50° C. and is preferably greater than 30° C.

11. A water heater heating control system as claimed in claim 10, wherein the desired output temperature from the water heater is achieved by the simple union of water from the cold water supply mixing with the water from the water heater.

12. A method of controlling the heating of a water heater, said method including:
(a) measuring the cold water supply temperature for a water heater tank;
(b) identifying or calculating a thermostat cut out temperature using the measured cold water supply temperature and a desired output temperature;
(c) closing the circuit with a heating element to heat water in said tank until the thermostat detects a temperature substantially the same as said temperature identified or calculated in step (b), whereupon said thermostat opens the circuit with the heating element.

13. A method as claimed in claim 12, wherein step (a) is performed before water from the cold water supply enters the tank.

14. A method as claimed in claim 12, wherein step (a) is performed after water from the cold water supply has entered the tank.

15. A method as claimed in claim 14, wherein step (a) is performed after a predetermined amount of hot water has been drawn from the tank.

16. A method as claimed in claim 14, wherein step (a) is performed prior to availability of off peak electricity supply.

17. A method as claimed in claim 12, wherein said cut out temperature is identified from a look up table stored in the control system of said water heater.

18. A method as claimed in claim 17, wherein said method includes the step of choosing the appropriate look up table based upon a desired output temperature and the cold water supply temperature.

19. A method as claimed in claim 12, wherein said cut out temperature is calculated from a desired output temperature and the cold water supply temperature.

20. A method as claimed in claim 19, wherein said cut out temperature is calculated by adding the cold water supply temperature to twice the difference between a desired output temperature and the cold water supply temperature.

21. A method of switching a water heater element, said method including the steps of:
(a) providing a solid state switching circuit and a relay connected in parallel thereto;
(b) initially closing the circuit between an electricity supply and said element by said solid state switching circuit in response to a control signal;
(c) after a predetermined time switching said relay.

22 A method as claimed in claim 21, wherein said solid state switching circuit is a triac.

23. A method as claimed in claim 21, wherein said predetermined time is approximately 20 milliseconds.

24. A method as claimed in claim 21, wherein said control signal maintains said solid state switching circuit in an ‘ON’ condition.

25. A method as claimed in claim 21, wherein to switch off the heater element the relay is switched off first.

26. A method as claimed in claim 25, wherein after a predetermined time the solid state switching circuit opens the circuit between the supply and the heater element.

27. A method as claimed in claim 21, wherein an AC supply is provided to said solid state switching circuit, said relay and said heating element and said solid state switching circuit will go to an ‘ON’ condition when the voltage is zero.

28. A water heater element control system, said system having a circuit between a water heater element and a solid state switching circuit and a relay connected in parallel thereto; whereby said solid state switching circuit initially closes the circuit between an electricity supply and said element in response to a control signal and after a predetermined time switching said relay.

29. A system as claimed in claims 28 wherein said solid state switching circuit is a triac.

30. A system as claimed in claim 28, wherein said predetermined time is approximately 20 milliseconds.

31. A system as claimed in claim 28, wherein said control signal maintains said solid state switching circuit in an ‘ON’ condition.

32. A system as claimed in claim 28, wherein to switch off the heater element the relay is switched off first.

33. A system as claimed in claim 32, wherein after a second predetermined time the solid state switching circuit opens the circuit between the supply and the heater element after the relay is switched off.

34. A system as claimed in claim 33, wherein said second predetermined time is 5 milliseconds.

35. A system as claimed in claim 34, wherein an AC supply is provided to said solid state switching circuit, said relay and said heating element and said solid state switching circuit will go to an ‘ON’ condition when the voltage is zero.

36. A method of controlling the heating of a water heater as claimed in claim 20, wherein said cut out temperature is identified from a look up table stored in non-volatile memory of the control system of said water heater, said memory being remotely programmable.

37. A method of controlling the heating of a water heater as claimed in claim 36, wherein said control system further includes the step of timing a delay from the turn-on of off-peak power before electricity is supplied to the thermostat and heater element of the water heater.

38. A method of controlling the heating of a water heater as claimed in claim 37, wherein said step of timing a delay includes storing a value corresponding to start of said delay into non-volatile memory and clearing said value once said delay has timed out.

39. A method of controlling the heating of a water heater as claimed in claim 37, wherein said value is cleared to zero if the continuity of supply of said off-peak power is interrupted.

40. A water heater heating control system including: a thermostat with an adjustable set-point temperature as claimed in claim 3, wherein said input/output relationship means is in the form of a look up table stored electronically including a non-volatile memory means programmed remotely.

41. A water heater heating control system including: a thermostat with an adjustable set-point temperature as claimed in claim 40, further including timing means for timing a delay from the turn-on of an electricity supply before said electricity is supplied to the thermostat and heater element of the water heater.

42. A water heater heating control system including: a thermostat with an adjustable set-point temperature as claimed in claim 41, wherein said timing means includes means to set a value corresponding to start of said delay in non-volatile memory means and means for resetting said value at end of said delay.

43. A water heater heating control system including: a thermostat with an adjustable set-point temperature as claimed in claim 42, further including means to reset said delay to zero if an interruption of said electricity supply occurs.

44. A water heater heating control system including: a thermostat with an adjustable set-point temperature as claimed in claim 43, wherein said delay is random.

45. A water heater heating control system including: a thermostat with an adjustable set-point temperature as claimed in claim 43, wherein said delay is biased.

46. A water heater heating control system including: a thermostat with an adjustable set-point temperature as claimed in claim 43, wherein said delay is calculated based on the time required to heat to the desired temperature the quantity of water to be heated knowing the capacity of the water heater, and the time available to do so over the period of electricity supply.
